(19) United States
(12) Patent Application Publication
(10) Pub. No.: US 2014/0188639 A1
(43) Pub. Date: Jul. 3, 2014

(54) Security Swipe System

(71) Applicant: Jeffrey Neil Dinardo, SR., West Babylon, NY (US)

(72) Inventor: Jeffrey Neil Dinardo, SR., West Babylon, NY (US)

(21) Appl. No.: 13/999,358

(22) Filed: Feb. 12, 2014

(51) Int. Cl. G06Q 20/32; G06Q 20/20

(52) U.S. Cl. CPC G06Q 20/3255; G06Q 20/20
USPC 705/17

(57) ABSTRACT

The present invention is a security and fraud prevention system which utilizes and controls security devices and uses short message text (SMS) notifications to enhance the security of point-of-sale credit or debit card transactions, using card swipe terminals at retail checkout stations. The invention, through the use of the System's firmware programmed on and located within the card swipe terminal, directs a remote digital camera located at the point-of-sale checkout station, to take a simultaneous photo of the respective cardholder, each time a credit or debit card is swiped at that checkout station. The photo is time stamped and stamped with the identical transaction number and transaction information, which is otherwise generated by the swipe terminal when the credit or debit card is swiped and details of the transaction are transmitted to the VPN for purchase authorization. The time stamped and fully identified photo is then stored on a remote server located on merchant's premises, for possible retrieval and use in the event of a fraudulent transaction. When the VPN receives the transaction for authorization from the participating merchant, it will be instructed to send an SMS text message to the cardholder. The SMS text message will alert the cardholder that its card has been used and ask whether or not that transaction has been attempted by the cardholder. If the cardholder responds yes, the transaction goes through as authorized. If the cardholder answers no, an additional prompt will ask the cardholder again, whether or not the cardholder is certain that the transaction is not theirs. If the no is confirmed, the VPN will alert the merchant that a fraudulent transaction has taken place and cancels the card to prevent future fraudulent use. The present invention then allows the merchant to retrieve the photo identification of the transaction and the perpetrator, to be used for possible prosecution of the violator and to create an in-house database of violators to be used by the merchant's security officers.

### BACKGROUND OF INVENTION

1. Field of Invention

This present invention relates generally to methods and systems providing for enhanced security at point-of-sale retail credit card swipe terminal checkout stations.

2. Background of the Invention

Swipe terminals at retail checkout stations are well known to consumers. Typically, the consumer or the retail clerk, upon checkout will swipe the consumer's credit or debit card through the credit card terminal, which will then transmit the cardholder's information and the transaction details to a VPD for authorization of the purchase. The VPN, utilizing its own methods of identification and authorization, including pin codes, makes a decision to authorize or decline the transaction. Although such methods are intended to prevent the likelihood of a fraudulent transaction, they do little or nothing to effectively lead to the apprehension of those attempting such fraudulent transaction or to identify such person for enhanced future scrutiny of such persons. Further, they do not provide an effective or even sufficient deterrent to potential perpetrators of credit card fraud.

The statistics provided by the U.S. Department of Justice for 2012 indicate that credit card fraud accounted for over 40% of all financial fraud committed in the U.S. for 2012. Further, the total amount of credit card fraud worldwide for 2011, topped $5.5 billion dollars. The problem of credit card fraud is growing steadily and measures are needed to enhance detection and prosecution of this crime.

What is required is a better method of collecting identification data of potential violators. What is required is a way of improving the likelihood of collecting detailed image data of potential violators and of securing that image data pertaining to the defrauding activity for future use by the targeted merchant in (i) prosecution of the violators,(ii) future identification of the violators; and (iii) as a deterrent to those considering credit card fraud at properly protected establishments.

3. Summary of the Invention

The above-noted limitations of the previously known and used credit cart swipe terminal systems have been overcome by a system and method that operates in accordance with the principles of this present invention.

The system of the present invention consists of the utilization of a remote digital camera; together with an SMS text messaging alert to the cardholder, in order to identify a fraudulent transaction and once identified, to memorialize the best evidence of the transaction, including photographic evidence of the perpetrator.

First, the cardholder will have previously opted-in with the card provider to receive SMS text alerts to its smartphone or iPhone, each time the card is swiped for a transaction. Once alerted to the card's attempted use, the cardholder will be asked to respond to whether or not it was the cardholder using the card. If yes, the transaction proceeds as normal. If no, the VPN will immediately cancel the card, effectively preventing future fraudulent use and will then notify the merchant, that a fraudulent transaction has taken place.

Once the merchant has been notified of the fraudulent transaction, the present invention will permit the merchant to retrieve evidence of the fraudulent transaction previously stored on its remote server. This evidence will include a time stamped photograph of the perpetrator swiping the card and all of the transaction details from when the transaction took place.

This present invention makes the retrieval of such information possible to the merchant by use of its enhanced security features. The present invention incorporates programmed firmware residing within the swipe terminal located at the retail point-of-sale checkout station. Once the card is swiped, the firmware directs a digital camera, mounted at the checkout station, to simultaneously take a photograph of the cardholder and transaction. The Photograph is then time stamped and imprinted with the transaction number and transaction details, otherwise generated by the terminal for transmission to the VPN for approval of the purchase. Once the photograph has been taken and stamped, the firmware directs its transmission to the merchant's remote server to be stored and ready for retrieval, should the transaction be proved to be fraudulent. And so, if the merchant receives notice of a fraudulent transaction, the present invention permits the merchant to retrieve a complete memorialization of the event; including photographic evidence of the perpetrator to be used for possible prosecution by law enforcement agencies and to be used in the merchant's database for future identification of the perpetrator by in-house security.

Increased identification of the perpetrators will allow for easier and more effective prosecutions, which will in turn act as an effective deterrent for those violators considering perpetrating credit card fraud at establishments protected by the present invention.

### BRIEF DESCRIPTION OF THE DRAWINGS

These and other features, aspects and advantages of the present disclosure will become better understood when the following detailed descriptions is read with reference to the accompanying drawings in which like characters represent like parts throughout the drawings, wherein:

FIG. 1 is a view of the Security Swipe System components working together. It illustrates the cardholder swiping the card, wherein a signal is sent, via the System's firmware programmed on and located within the credit card swipe terminal, to a remote digital camera to photograph the transaction. The photograph is then time stamped and stamped with the transaction number and all of the information normally generated by the swipe terminal for transmission to the VPN when requesting transaction approval. Finally, the time and transaction information stamped photograph is then transmitted to a remote server housed at the merchant's location, for future retrieval and use in the event of a fraudulent transaction.

FIG. 2 is a detailed view of the alert sent by the VPN to the previously opted-in cardholder, that its credit or debit card has been used. Upon receiving the alert, the cardholder will be asked whether or not it initiated the transaction. If the answer is yes, the transaction proceeds as normal. If the answer is no, the cardholder will be prompted to confirm its no response. If the no response is confirmed, the VPN will cancel the card to prevent future fraudulent use and will notify the merchant that a fraudulent transaction has taken place. The System will then permit the merchant to retrieve the photographic evidence of the transaction from its remote server to be used for possible prosecution of the violator.

FIG. 3 is a representation of the hardware utilized by the present invention and details the credit card swipe terminal, FIG. 3.1; the digital camera mounted at the checkout station, FIG. 3.2; the merchant's remote server to store the gathered information, FIG. 3.3 and the cardholder's smartphone or i-phone, opted-in to receive SMS text alerts of the transactions, FIG. 3.4.

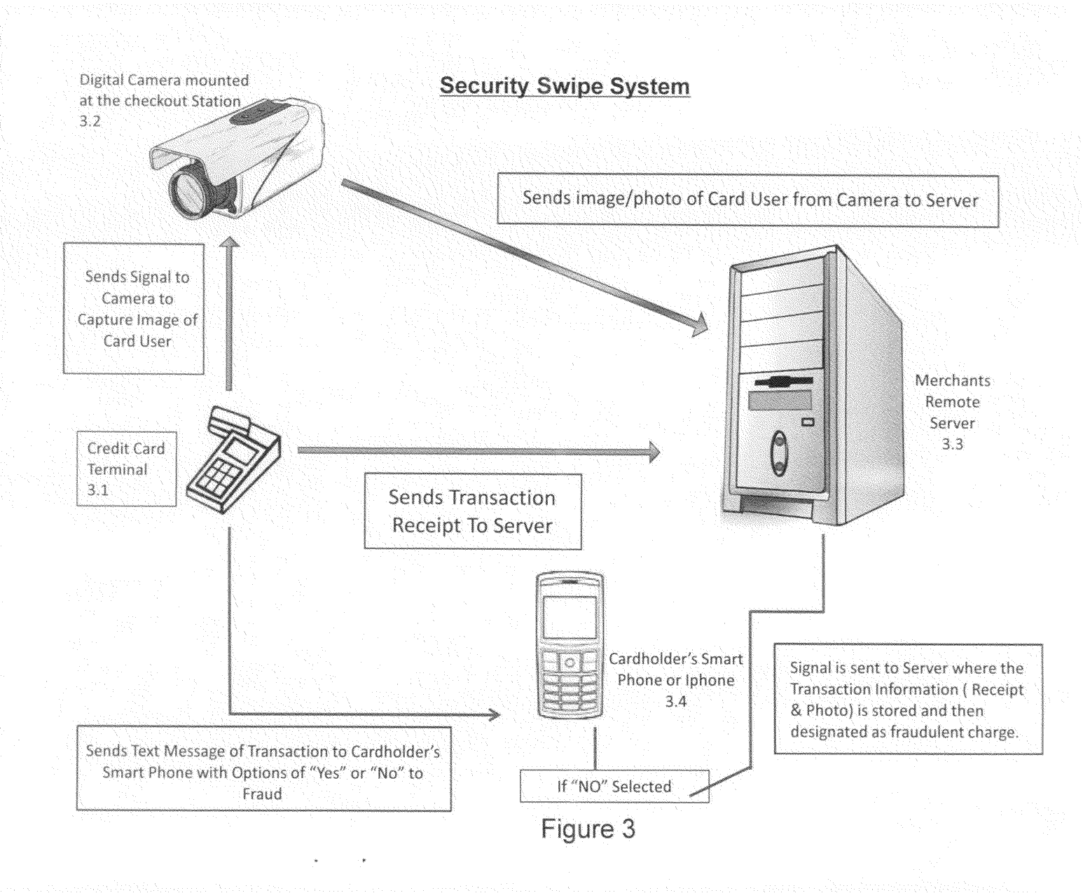

### DETAILED DESCRIPTION OF SPECIFIC EMBODIMENTS

One or more of the specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made in order to achieve the developers' specific goals, such as compliance with system related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present disclosure is directed to techniques for enhancing the security of point-of-sale credit card transactions, which utilize a credit card swipe terminal, whereby the cardholder is required to swipe its credit or debit card at a retail checkout terminal in order to pay for a purchase transaction.

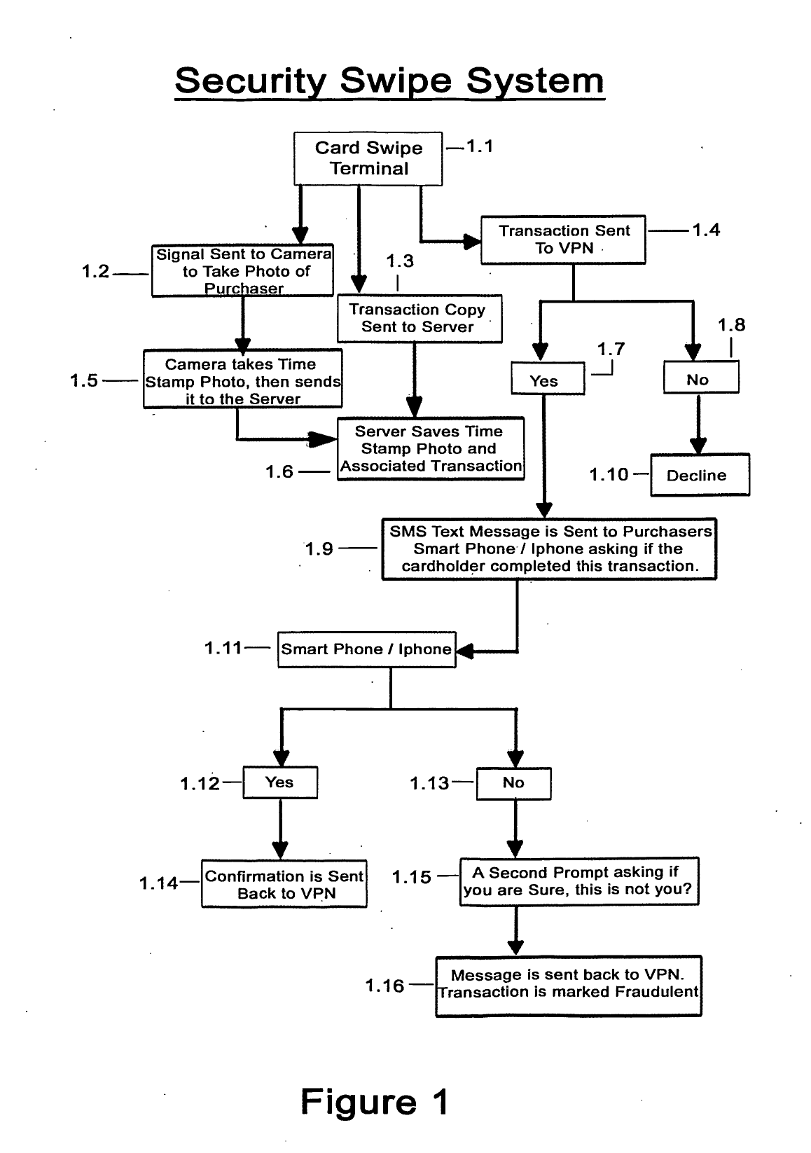

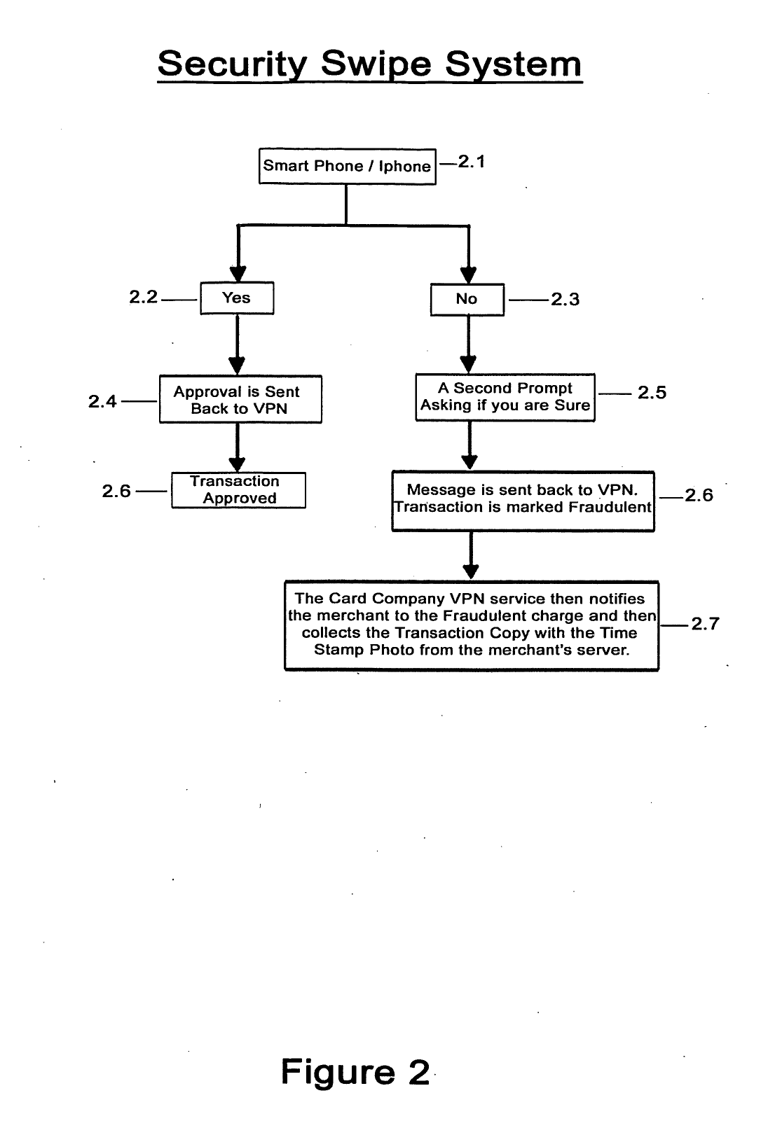

FIG. 1 and FIG. 2 illustrate the techniques utilized by the present invention to provide enhanced security in the point-of-sale credit card payment transaction. Typically, the cardholder is requested to swipe its credit or debit card through the credit card swipe terminal located at the check-out station of the retail establishment. FIG. 1.1. Typically, the swiping of the credit or debit card by the cardholder through the swipe terminal initiates and directs the terminal's firmware to read the information contained on the card's magnetic strip and to forward that information to a remote VPN for authorization of the purchase. FIG. 1.4. This present invention utilizes additional firmware instructions programmed on and residing within the card swipe terminal to direct a digital camera, located at the point-of-sale checkout station, to simultaneously take a photo of the cardholder swiping the card. FIG. 1.2. The digital camera then takes the photo, times tamps the photo and codes the photo with the transaction number and transaction details sent to the VPN for approval. FIG. 1.5. After taking the photo of the cardholder and transaction, the digital camera then transmits the time stamped and transaction detailed photo to a remote server for storage and future retrieval. FIG. 1.6.

The present invention then utilizes the cardholder's smartphone or iPhone telephone number, previously provided by the cardholder when the cardholder voluntarily opted-in for receipt of short message text alerts from the card provider, whenever the card was used in a transaction. FIG. 1.7, 1.8. 1.9. A text message is then sent to the cardholder asking if the purchase transaction was completed by the cardholder or not. If yes, the transaction proceeds as authorized. If no, the VPN notifies the merchant that a fraudulent transaction has taken place and cancels the card for future charges. FIG. 2.6, 2.7.

The merchant, after receiving notice that the transaction was fraudulent can then retrieve the time stamped photo of the transaction from the remote server and can identify the perpetrator of the fraud and provide evidence of the fraudulent transaction to law enforcement agencies for possible prosecution. The photo identification also enables the merchant to construct its own database of violators for use by its in-house security staff.

What is claimed is:

1. A security and credit card fraud prevention system utilizing a remote digital camera, connected by firmware, to the credit card swipe terminal located at the point-of-sale checkout station and cardholder alerts via short messaging systems (SMS) provided on smartphones and/or iPhones to captures and memorialize potential fraudulent transaction and alerts the cardholder to possible fraudulent use of its credit or debit card, at the time of the transaction.

2. A system as claimed in claim 1, wherein the cardholder voluntarily opts-in with the card provider to receive SMS text alerts each time the respective credit or debit card is used in a transaction.

3. A system as claimed in claim 1, wherein when the credit or debit card is swiped through a credit card swipe terminal located at the point-of-sale retail checkout station, the systems firmware programmed on and located within the swipe terminal, will direct a remote digital camera, located at the checkout station, to take a photo of the transaction. The digital camera will then time stamp the photo and stamp the photo with the transaction number and transaction details generated by the swipe machine for transmission to the VPN for transaction approval.

4. A system as claimed in claim 1 and claim 3, wherein the time stamped and transaction identified photo will be transmitted to a remote server located on the merchant's premises, to be available for future retrieval and use in the event of a fraudulent transaction.

5. A system as claimed in claim 1 and claim 2, wherein the cardholder is alerted by an SMS, short message text, that its card has been used and asking the cardholder whether or not they are the one who has used the card. If the response to the text is yes, the transaction proceeds as normal. If the response is no, the VPN alerts the merchant of the fraudulent transaction and cancels the card to prevent further fraudulent use.

6. A system as claimed in claim 1 and claim 3, wherein the merchant after receiving notification that a particular transaction was fraudulent can retrieve photographic evidence of the transaction from its remote server. The photo will identify the perpetrator and together with the details of the transaction, can be used by law enforcement agencies in possible prosecutions. The photo can also be used by the merchant in its in-house security system for future identification of the violator.
